(19) United States
(12) Patent Application Publication
(10) Pub. No.: US 2017/0201689 A1
(43) Pub. Date: Jul. 13, 2017

(54) REMOTELY CONTROLLED COMMUNICATED IMAGE RESOLUTION

(71) Applicant: PROJECT RAY LTD., Yokneam (IL)

(72) Inventors: Boaz ZILBERMAN, Ramat Hasharon (IL); Michael VAKULENKO, Zichron Yaakov (IL); Nimrod SANDLERMAN, Ramat-Gan (IL)

(21) Appl. No.: 15/399,544

(22) Filed: Jan. 5, 2017

Related U.S. Application Data
(60) Provisional application No. 62/276,871, filed on Jan. 10, 2016.

(51) Int. Cl. H04N 5/232; H04N 1/393; H04N 1/00; H04N 13/02

(52) U.S. Cl. CPC H04N 5/23293; H04N 13/0207; H04N 1/3935; H04N 1/00307; H04N 5/23296

(57) ABSTRACT

A method, a device, and a computer program for remotely controlling image resolution of communicated imaging data executing actions such as: converting a high-resolution image to low-resolution and communicating the low-resolution image to a remote display device, displaying the low-resolution image on a display of the remote display device in real-time, receiving a user selection at the remote display device of a portion of the low-resolution image where the selected image portion is associated with a portion identifier, communicating the portion identifier to the device acquiring the image data in real-time, and communicating a high-resolution image associated with the selected image portion from the image-acquiring device to the remote display device, where the high-resolution image is a close-up (zoom-in) view of the low-resolution image including the selected image portion.

### FIELD

The method and apparatus disclosed herein are related to the field of communicating imaging, and, more particularly, but not exclusively to systems and methods for controlling the resolution of a communicated image.

### BACKGROUND

Communicating images is well known in the art, including communicating images in real-time. Due to the rich amount of data contained by the imaging, and the limited bandwidth of the communication media, limitation on the resolution of the communicated image is useful and well known, including various compression methods. It is therefore known and used in the art to obtain image data in relatively high-resolution, and communicate image data in reduced, or relatively low, resolution. It is also known to control the communicated resolution according to needs, for example, as disclosed in US patent applications 20040120591 and 20080060032. However, due to the increased level of resolution of the cameras in use, the limited bandwidth of the communication media remains an obstacle for sourcing high-resolution imaging in real-time or near real-time situations. There is thus a widely recognized need for, and it would be highly advantageous to have, a system and method for remotely controlling image resolution of the communicated imaging devoid of the above limitations.

### SUMMARY OF THE INVENTION

According to one exemplary embodiment there is provided a method, a device, and a computer program for remotely controlling image resolution of the communicated imaging, the method, device, and/or computer program executing actions such as: acquiring the image by an image acquiring device, the image being acquired at high-resolution, converting the image to low-resolution by the image acquiring device to form a low-resolution image, associating at least one portion of the low-resolution image with a portion identifier, communicating the low-resolution image and the at least one portion identifier from the image acquiring device to a remote display device, displaying the low-resolution image on a display of the remote display device in real-time, receiving a user selection, at the remote display device, of a portion of the low-resolution image to form a selected image portion to form an image-portion selection, where the selected image portion is associated with a portion identifier, communicating the portion identifier to the image acquiring device, and communicating a high-resolution image associated with the selected image portion from the image acquiring device to the remote display device, where the high-resolution image is a close-up (zoom-in) view of the low-resolution image including the selected image portion.

According to another exemplary embodiment the image may be at least one of a still picture and a video stream, and the remote display device may be a mobile communication device.

According to still another exemplary embodiment the portion identifier may be associated with at least one of: portion index, frame number, time of acquiring the image, location of acquiring the image, orientation of the camera when acquiring the image, and section of the image.

According to yet another exemplary embodiment the portion identifier may include at least one of an absolute value, a relative value, and an index.

Further according to another exemplary embodiment the action of determining the portion may include pointing at the portion on the display.

Still further according to another exemplary embodiment the output device of the remote display device may include a touch-screen display.

Yet further according to another exemplary embodiment the resolution may include at least one of spatial resolution (such as pixel density), temporal resolution, (such as frame-rate or time), color resolution (such as bits per pixel), and the amount of data loss, for example, due to compression.

Additionally, according to another exemplary embodiment, the action of determining the portion may include selecting high-resolution of at least one of the spatial resolution, temporal resolution, color resolution, and loss of data.

According to another exemplary embodiment the method, device, and/or computer program may additionally include actions such as dividing the image at the image acquiring device into a plurality of portions according to loss of data due to compression (higher loss—smaller portion).

According to still another exemplary embodiment the method, device, and/or computer program may additionally include actions such as displaying portion boundary on the display.

According to yet another exemplary embodiment the image acquiring device may include a plurality of image acquiring devices and the action of receiving the image-portion selection may include selecting an image acquiring device of the plurality of image acquiring devices.

Further according to another exemplary embodiment at least one of the plurality of image acquiring devices is a three-dimensional (3D) scanner, and at least one of the image may include 3D data, the high-resolution may include 3D data, and the action of determining a portion of the image may include adding the 3D data to the portion.

Still further according to another exemplary embodiment the action of selecting an image acquiring device may include selecting at least one of a forward-looking camera and a backward-looking camera.

Yet further according to another exemplary embodiment the action of receiving the image-portion selection may include selecting at least one of: an image portion taken by the forward-looking camera and associated with an image portion taken by the backward-looking camera, and an image portion taken by the backward-looking camera and associated with an image portion taken by the forward-looking camera.

Even further according to another exemplary embodiment the actions of receiving a user selection at the remote display device of a portion of the low-resolution image, communicating the portion identifier to the image acquiring device, and communicating a high-resolution image associated with the selected image portion from the image acquiring device to the remote display device, are executed repeatedly to provide at least one of: increased resolution, and required level of details.

Additionally, according to another exemplary embodiment the method, device, and/or computer program the actions of communicating the portion identifier to the image acquiring device, and communicating a high-resolution image associated with the selected image portion from the image acquiring device to the remote display device, are executed repeatedly to provide an adjacent image portion.

According to another exemplary embodiment the adjacent image portion may include resolution of previous image portion.

According to still another exemplary embodiment the method, device, and/or computer program may additionally include at least one action such as: sending, from the remote device to the image acquiring device, a request for a second high-resolution image associated with the same image portion and taken in a different time, and sending, from the image acquiring device to the remote device, a second high-resolution image associated with the same image portion and taken in a different time.

According to yet another exemplary embodiment there is provided a method, a device, and a computer program for remotely controlling image resolution of the communicated imaging, the method, device, and/or computer program executing actions such as: acquiring the image by an image acquiring device including an image acquiring device, the image being acquire at high-resolution, converting the image to low-resolution by the image acquiring device to form a low-resolution image in real-time, communicating the low-resolution image from the image acquiring device to a remote display device in real-time, displaying the low-resolution image on a display of the remote display device in real-time, receiving a user selection, at the remote display device, of a point location within the low-resolution image, communicating the point location to the image acquiring device, and communicating a high-resolution image associated with the selected image portion from the image acquiring device to the remote display device, where the high-resolution image covers a part of the low-resolution image including the point location.

Further according to another exemplary embodiment the high-resolution image may include at least one of: a selected area of the low-resolution image, a selected number of pixels of the high-resolution image, a selected time between two of the low-resolution image, and a selected frame-rate.

Still further according to another exemplary embodiment the high-resolution image may include at least one of: a predetermined area of the low-resolution image, a predetermined number of pixels of the high-resolution image, a predetermined time between two of the low-resolution image, and a predetermined frame-rate.

Yet further according to another exemplary embodiment the remote display device may be an image acquiring device and where the predetermined number of pixels is adapted to a display of the remote display device.

Even further according to another exemplary embodiment the method, device, and/or computer program may additionally execute actions such as: receiving a user selection, at the remote display device, of a second point location, the second point location selected within the high-resolution image, communicating a second point location to the image acquiring device, and communicating a second high-resolution image associated with the second point location from the image acquiring device to the remote display device, where the second high-resolution image covers a second part of the low-resolution image including the second point location.

Additionally, according to another exemplary embodiment, the second high-resolution image may be at least one of: adjacent to the first high-resolution image, partially overlapping the first high-resolution image, including same resolution as the first high-resolution image, including same area size as the first high-resolution image, and including same number of pixels as the first high-resolution image.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to actions or stages of methods and processes described in this disclosure, including the figures, is intended or implied. In many cases the order of process actions may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified illustration of a system for remotely controlling communicated image resolution;

FIG. 2 is a simplified block diagram of a computing system for remotely controlling communicated image resolution;

FIG. 3 is a simplified illustration of a remote-resolution communication channel for remotely controlling communicated image resolution;

FIG. 4A is a simplified illustrations of a low resolution image images;

FIG. 4B is a simplified illustrations of a medium-resolution image of a portion of the image of FIG. 4A;

FIG. 4C is a simplified illustrations of a high-resolution image of a portion of the image of FIG. 4B;

FIG. 5 is a simplified flow-chart of a process 1 for remotely selecting image resolution;

FIG. 6 is a simplified illustration of an image divided into image portions, and associated with respective portion identifiers; and

FIG. 7 is a simplified illustration of an image having preselected image portions.

### DESCRIPTION OF THE PREFERRED EMBODIMENTS

The present embodiments comprise systems and methods for remotely controlling image resolution of the communicated imaging. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of the embodiments is to provide at least one system and/or method enabling a remote user and/or remote system to control the resolution of an image communicated from a local camera.

The term “local camera” refers to a camera obtaining images (or imaging data) in a first location and the terms “remote user” and “remote system” refer to a user or a system viewing or analyzing the images obtained by the local camera in a second location, where the second location is remote from the first location.

The term ‘resolution’ herein, such as in high-resolution, low-resolution, higher-resolution, intermediate-resolution, etc., may refer to any aspect related to the amount of information associated to any type of image. Such aspects may be, for example:
Spatial resolution, or granularity, represented, for example, as pixel density or the number of pixels per area unit (e.g., square inch or square centimeter).
Temporal resolution, represented, for example, the number of images per second, or as frame-rate.
Color resolution or color depth, or gray level, or intensity, or contrast, represented, for example, as the number of bits per pixel.
Compression level or type, including, for example, the amount of data loss due to compression. Data loss may represent any of the resolution types, or aspects, described herein, such as spatial, temporal and color resolution.
Any combination thereof.

The term ‘resolution’ herein may also be known as ‘definition’, such as in high-definition, low-definition, higher-definition, intermediate-definition, etc.

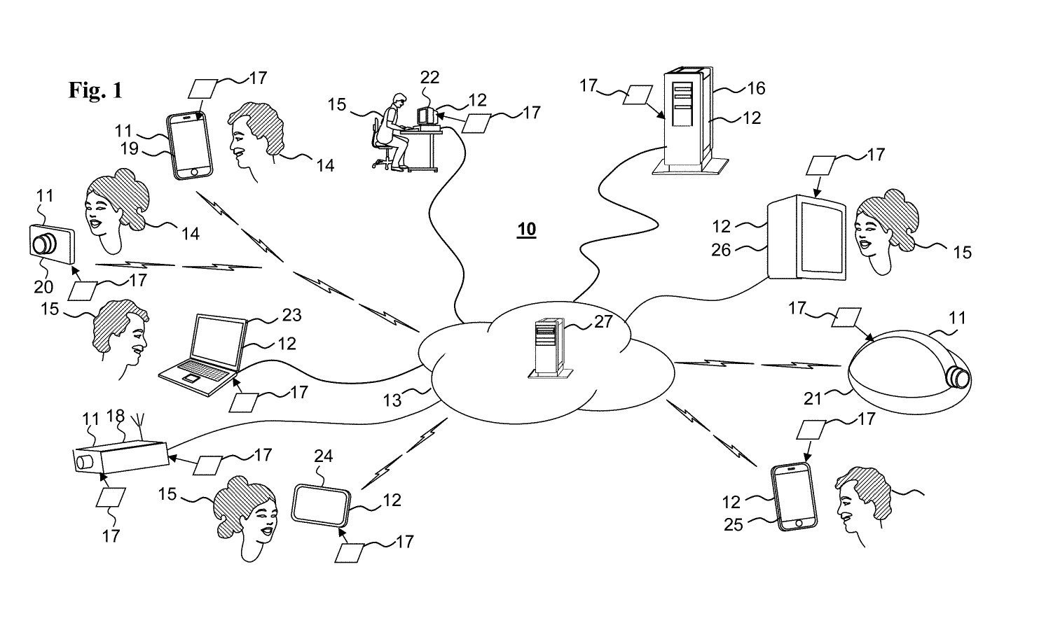

Reference is now made to FIG. 1, which is a simplified illustration of a system for remotely controlling communicated image resolution 10, according to one exemplary embodiment. The system for remotely controlling communicated image resolution 10 may be named herein system 10 for short.

As shown in FIG. 1, System 10 may include at least one local camera 11 in a first location, and at least one remote viewing station 12 in a second location. A communication network 13 connects between local camera 11 and the remote viewing station 12. Camera 11 may be operated by a first local user 14, while remote viewing station 12 may be operated by a second, remote user 15. The remote viewing station 12 may be named herein a ‘remote display device’.

Alternatively or additionally, the local camera 11 may be an autonomous device, operated by a computing machine. The remote viewing station 12 may be operated by, or implemented as, a computing machine 16 such as a server, which may be named herein ‘imaging server 16’, or ‘remote display device’.

Camera 11 may be any type of computing device including any type of imaging device. Local camera 11 may include resolution control software 17 or a part of resolution control software 17, remote viewing station 12 may include resolution control software 17 or a part of resolution control software 17, and/or imaging server 16 may include resolution control software 17 or a part of resolution control software 17.

The term ‘camera’, and particularly camera 11, refer to any type of imaging device that is capable of providing an image of at least one image type or imaging technology. The terms ‘imaging device’, mobile ‘communication device’, and camera 11 may be used herein interchangeably referring to a computing device including a camera or any other type of imaging device operative to acquire any type of imaging data.

The terms ‘image type’ or ‘imaging technology’ refer to, for example, a still picture, a sequence of still pictures, a video clip or stream, a 3D image, a thermal (e.g., IR) image, stereo-photography, surround imaging (e.g., still photography and/or video using a fish-eye lens), and/or any other type of imaging data and combinations thereof.

Camera 11 may include an imaging device capable of providing one or more image types of imaging technologies. Camera 11 may be a fixed camera (18) or can be part of a mobile computing device such as a smartphone (19). Camera 11 may be hand operated (20) or head mounted (or helmet mounted 21), car mounted (e.g., dashboard camera), etc. Each camera 11 may include a remote-resolution local-imaging module.

Camera 11 may include a storage device for storing the imaging data collected by camera 11. However, alternatively or additionally, such storage device may be provided externally to camera 11, whether collocated with camera 11 or remotely. It is appreciated that where the description refers to communication between camera 11 and remote viewing station 12 and/or imaging server 16 this action may include such communication between the storage device and the remote viewing station 12 and/or imaging server 16. Similarly, such action of communication may include any type of computing device operating the storage device communicating with the remote viewing station 12 and/or imaging server 16.

Remote viewing station 12 may be any computing device such as a desktop computer 22, a laptop computer 23, a tablet or PDA 24, a smartphone 25, a monitor 26 (such as a television set), a three-dimensional (3D) display, a head-up display, a stereoscopic display, a virtual reality headset, etc. Remote viewing station 12 may include a display (e.g., a screen display) for use by a remote second user 15. Each remote viewing station 12 may include a remote-resolution remote-imaging module.

Communication network 13 may be any type of network, and/or any number of networks, and/or any combination of network types. For example, communication network 13 may be, or include a fixed (wire, cable) network, a wireless network, and/or a satellite network. Communication network 13 may be a wide area network (WAN, fixed or wireless, including various types of cellular networks), a local area network (LAN, fixed or wireless), and a personal area network (PAN, fixes or wireless).

Communication network 13 may be characterized as ‘limited bandwidth’. Communicating imaging data over a limited bandwidth communication network, for example, from the camera to the viewing station, and/or from the camera to the imaging server, or from the imaging server to the viewing station, may force the transmitter to reduce the quality, or the resolution, of the transmitted image, so that, for example, the communicated imaging data may reach the receiver in due time.

A distribution server 27 may be part of the communication network 13 (as shown in FIG. 13), or externally connected to communication network 13.

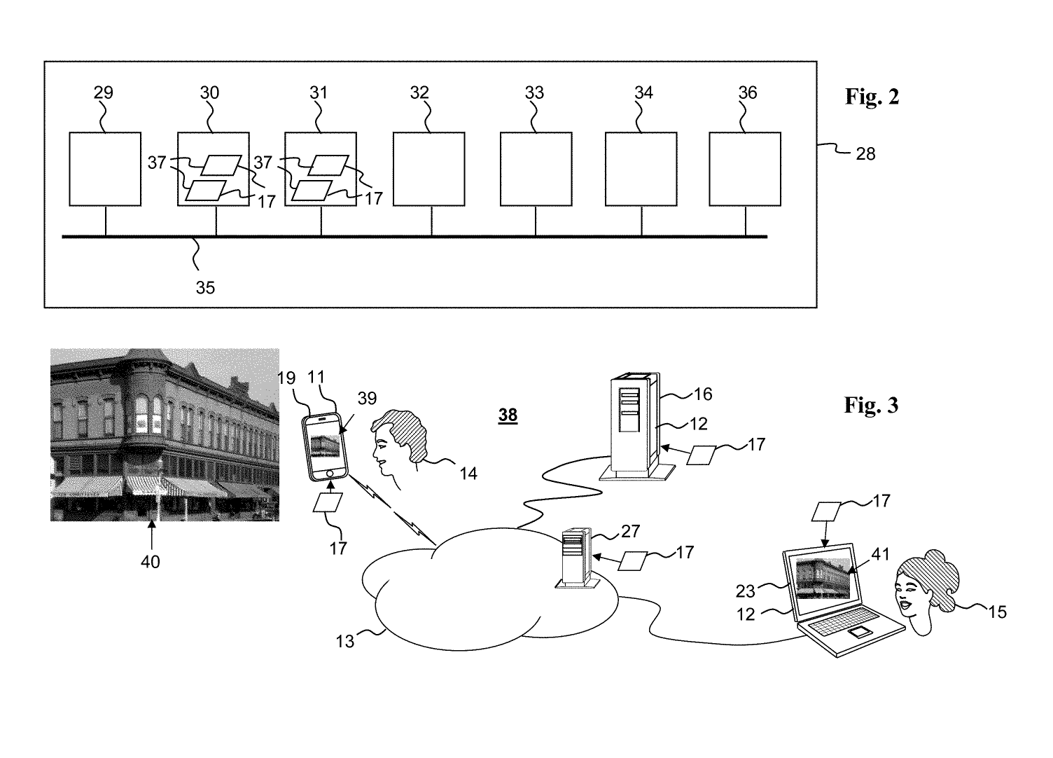

Reference is now made to FIG. 2, which is a simplified block diagram of a computing system 28 for remotely controlling communicated image resolution, according to one exemplary embodiment. As an option, the block diagram of FIG. 2 may be viewed in the context of the details of the previous Figures. Of course, however, the block diagram of FIG. 2 may be viewed in the context of any desired environment. Further, the aforementioned definitions may equally apply to the description below.

Computing system 28 is a block diagram of an example of an imaging device such as camera 11, or a computing device hosting an imaging device such as camera 11. The term ‘computing system’ or ‘computing device’ relates to any type or combination of computing devices, or computing-related units, including, but not limited to, a processing device, a memory device, a storage device, and/or a communication device.

As shown in FIG. 2, computing system 28 may include at least one processor unit 29, one or more memory units 30 (e.g., random access memory (RAM), a non-volatile memory such as a Flash memory, etc.), one or more storage units 31 (e.g. including a hard disk drive and/or a removable storage drive, representing a floppy disk drive, a magnetic tape drive, a compact disk drive, a flash memory device, etc.). Computing system 28 may also include one or more communication units 32, one or more graphic processors 33 and displays 34, and one or more communication buses 35 connecting the above units.

In the form of camera 11, computing system 28 may also include an imaging sensor 36 configured to create a still picture, a sequence of still pictures, a video clip or stream, a 3D image, a thermal (e.g., IR) image, stereo-photography, and/or any other type of imaging data and combinations thereof.

Computing system 28 may also include one or more computer programs 37, or computer control logic algorithms, which may be stored in any of the memory units 30 and/or storage units 31. Such computer programs, when executed, enable computing system 28 to perform various functions (e.g. as set forth in the context of FIG. 1, etc.). Memory units 30 and/or storage units 31 and/or any other storage are possible examples of tangible computer-readable media. Particularly, computer programs 37 may include resolution control software 17 or a part of resolution control software 17.

Particularly, computing system 28 in the form of camera 11 may include the following modules:

An image acquiring module configured to acquire high-resolution imaging data.

A resolution conversion module, typically implemented as a module of resolution control software 17, configured to convert the high-resolution imaging data into low-resolution imaging data.

A communication module configured to communicate the low-resolution imaging data to a remote display device, to receive from the a remote display device a portion identifier associated with a user selection at the remote display device of a portion of the low-resolution imaging data, and communicate a high-resolution imaging data associated with the selected image portion to the remote display device.

A portion association module, typically implemented as a module of resolution control software 17, configured to associate a portion of an image with a portion identifier.

In the form of remote viewing station 12 (or a computing device hosting remote viewing station 12, and/or an imaging server 16 or a computing device hosting imaging server 16) computing system 28 may also include:

A communication module configured to receive a low-resolution imaging data from camera 11, to transmit to camera 11 a portion identifier associated with a portion of the low-resolution imaging data, and to receive from the another processing device a high-resolution imaging data associated with the portion identifier.

A display module configured to display to a user at least one of the low-resolution imaging data and the high-resolution imaging data;

A user-interface module configured to receive from the user a selection of at least one of: a point location and an area portion, within the low-resolution image;

A portion-identifier processing module configured to convert or to associate the at least one of: a point location and an area portion into the portion identifier.

Reference is now made to FIG. 3, which is a simplified illustration of a remote-resolution communication channel 38 for remotely controlling communicated image resolution, according to one exemplary embodiment. As an option, the illustration of FIG. 3 may be viewed in the context of the details of the previous Figures. Of course, however, the illustration of FIG. 3 may be viewed in the context of any desired environment. Further, the aforementioned definitions may equally apply to the description below.

As shown in FIG. 3, remote-resolution communication channel 38 may include a camera 11 (i.e., local camera 11) typically operated by a first, local, user 14 and a remote viewing station 12, typically operated by a second, remote, user 15. Camera 11 and remote viewing station 12 typically communicate over communication network 13. Remote-resolution communication channel 38 may also include imaging server 16 and/or distribution server 27. Camera 11, and/or remote viewing station 12, and/or imaging server 16 may include computer programs 37, which may include resolution control software 17 or a part of resolution control software 17.

A session between a first, local, user 14 and a second, remote, user 15 may start by the first user 14 calling the second user 15 requesting help, for example, navigating, and/or orienting (finding the appropriate direction), and/or identifying or interpreting a particular visual object, etc. In the session, the first user 14 operates the camera 11 and the second user 15 views the images provided by the camera and directs the first user 14.

Additionally and optionally, the second (remote) user 15 may communicate various instructions to the first (local) user 14. Additionally and optionally, remote viewing station 12, and/or imaging server 16, may communicate various instructions and/or imaging data to camera 11 (or to a computing device including camera 11).

It is appreciated that the term ‘remote-resolution communication channel’ is not restricted to any type of communication technology or channel and may include more than a single type or a single instance of communication channels. It is appreciated that the communication between the first and second users and between camera 11 and remote viewing station 12, and/or imaging server 16, may be implemented over different communication channels (e.g., different communication technologies).

Particularly, the imaging data communicated from camera 11 to remote viewing station 12, and/or imaging server 16, may be transmitted and received over a first channel, for example, a communication channel configured for streaming applications, while data communicated from remote viewing station 12, and/or imaging server 16, to camera 11 and may be transmitted and received over a second channel, for example, a communication channel configured for messaging applications.

It is appreciated that any part of the communication channel, or remote-resolution communication channel, mat be characterized as a limited bandwidth network.

A typical reason for the first user to request the assistance of the second user is a difficulty seeing, and particularly a difficulty seeing the image taken by the camera. Such reason is that the first user is visually impaired, or being temporarily unable to see. The camera display may be broken or stained. The first user's glasses, or a helmet protective glass, may be broken or stained. The user may hold the camera with the camera display turned away or with the line of sight blocked (e.g., around a corner). Therefore, the first user does not see the image taken by the camera, and furthermore, the first user does not know where exactly the camera is directed. Therefore, the images taken by the camera 11 operated by the first user 14 may be quite random, for example, with respect to their spatial orientation.

In some scenarios the user may be able to see the screen display of the camera 11 or the hosting computing device 19, and still require remote assistance. For example, the camera may have better resolution than the user, either because the user is partially impaired, or because the camera has better resolution than the human eye. For example, the camera may have better color depth or wider color bandwidth such as ultraviolet and/or infrared imaging capabilities. For example, the camera may have better resolution than its screen display or the screen display of the hosting computing device 19. In such cases the first (local) user 14 may require assistance of a second (remote) user 15 how may have access to a remote viewing station 12 equipped with better imaging display capabilities that may make the most of the qualities of the captured image.

The first user 14 may call the second user 15 directly, for example by providing camera 11 with a network identification of the second user 15 or the remote viewing station 12. Alternatively, the first user 14 may request help and the distribution server 27 may select and connect the second user 15 (or the remote viewing station 12). Alternatively, the second user 15, or the distribution server 27 may determine that the first user 14 needs help and initiate the session. Unless specified explicitly, a reference to a second user 15 or a remote viewing station 12 refers to an imaging server 16 too.

As shown in FIG. 3, the first (local) user 14 operating camera 11 has captured an image 39 of, for example, an urban landscape 40, and communicated the image, typically in a lower-quality (lower-resolution) form 41, to a remote viewing station 12, which displays the image to the second (remote) user 15.

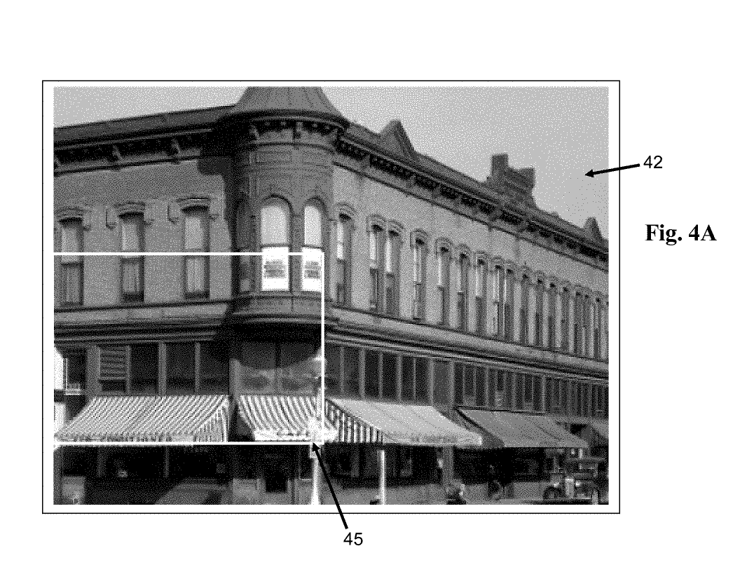

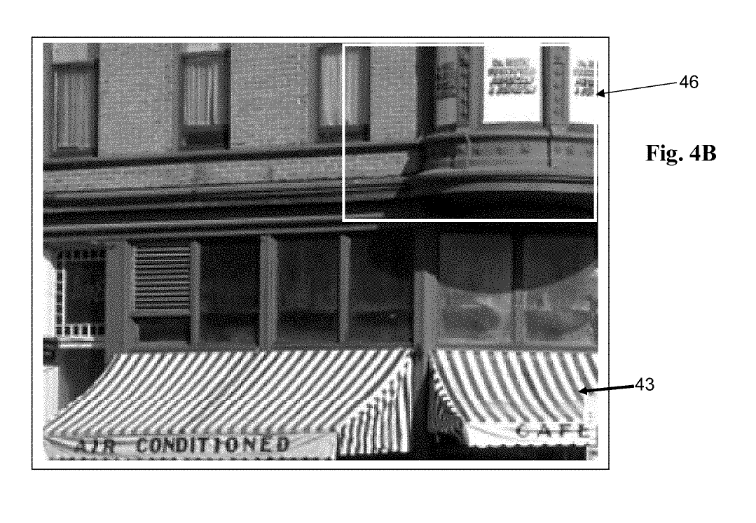

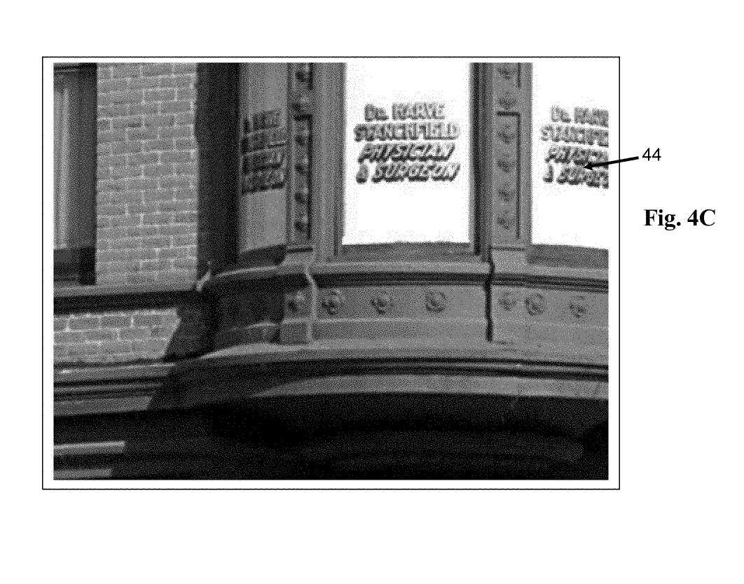

Reference is now made to FIG. 4A, FIG. 4B, and FIG. 4B, which are simplified illustrations of an images 42, 43, and 44, respectively, according to one exemplary embodiment.

As an option, the illustration of FIG. 4 may be viewed in the context of the details of the previous Figures. Of course, however, the illustration of FIG. 4 may be viewed in the context of any desired environment. Further, the aforementioned definitions may equally apply to the description below.

As shown in FIG. 4, image 43 is a higher resolution detail 45 of image 42, and image 44 is a higher resolution detail 46 of image 43. For example, image 43 includes more pixels than image 42 and image 44 includes more pixels than image 43. Detail 45 may be considered an image portion of image 42, and detail 46 may be considered an image portion of image 43.

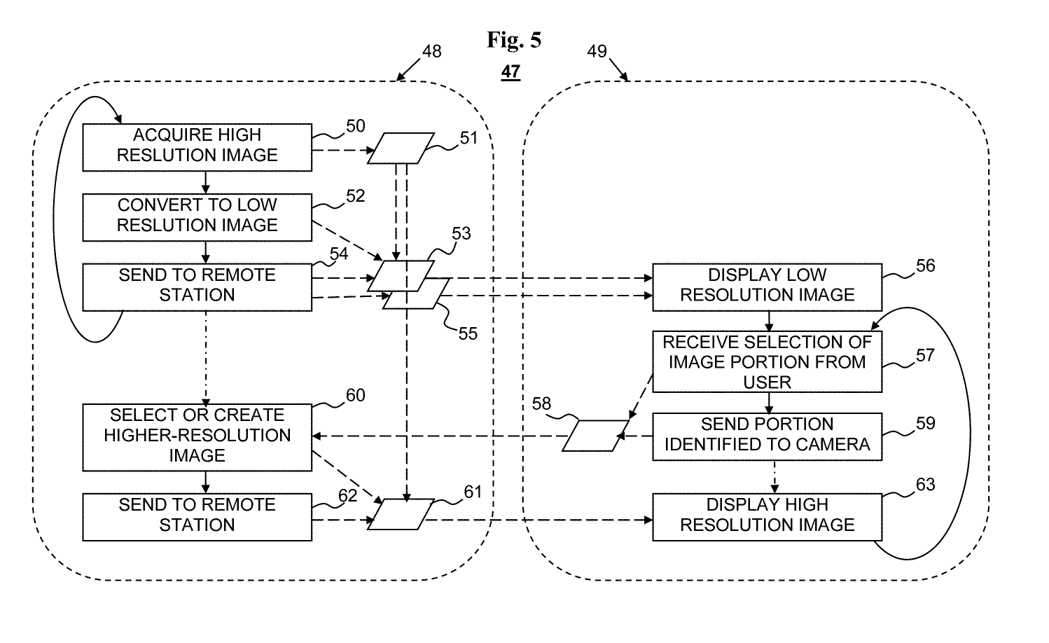

Reference is now made to FIG. 5, which is a simplified flow-chart of a process 47 for remotely selecting image resolution, according to one exemplary embodiment.

As an option, the flow-chart of FIG. 5 may be viewed in the context of the details of the previous Figures. Of course, however, the flow-chart of FIG. 5 may be viewed in the context of any desired environment. Further, the aforementioned definitions may equally apply to the description below.

As shown in FIG. 5, process 47 may include at least two procedures. Procedure 48 may be operated by the first, or local, user 14, and/or executed by a processor of camera 11. Procedure 49 may be operated by the second, or remote, user 15, and/or executed by a processor of remote viewing station 12 and/or imaging server 16. Other procedures of process 47 may be executed by servers such as distribution server 27.

As shown in FIG. 5 and shown and described above with reference to FIGS. 1 and 3, process 47 may start with step 50 of procedure 48, where camera 11, typically operated by the first, or local, user 14, acquires a high-resolution image 51. Image 51 may be a still picture, a sequence of still pictures, a video clip or stream, a 3D image, a thermal (e.g., IR) image, stereo-photography, and/or any other type of imaging data and/or combinations thereof.

Process 47 may then continue with step 52 of procedure 48, where camera 11 may convert high-resolution image 51 into a low-resolution image 53, such as image 42 of FIG. 4A. Process 47 may then continue with step 54 of procedure 48 by sending low-resolution image 53 to a remote viewing station 12. The term ‘send’ herein may also be interpreted as transmitted and/or communicated.

Additionally and/or optionally, procedure 48 may also send portioning data 55, for example, as part of step 54. Portioning data 55 may include data defining one or more image portions within one or more of the images of low-resolution image 53. Portioning data 55 may, for example, include the boundaries of such image portion, and/or a portion identifier associated with the image portion. Alternatively, portioning data 55 may include the portion identifier, coordinates of a point within one or more of the images of low-resolution image 53, and a definition of an area associated (e.g., surrounding) the point. Alternatively, Portioning data 55 may include one or more rules for dividing the images of low-resolution image 53 into portions. Particularly, portioning data 55 enables a viewing station and/or an image server to locate at least one image portion within its respective low-resolution image 53.

As will be described below, there may be at least one embodiment in which camera 11, and/or procedure 48 may create the portioning of low-resolution image 53 into image portions and then sends both low-resolution image 53 and the associated portioning data 55 to remote viewing station 12. Alternatively, in another embodiment, remote viewing station 12 may create the portioning of low-resolution image 53 into image portions.

Alternatively, in another embodiment, the portioning is predetermined, for example, according to a predetermined method or algorithm. For example, all images may be divided into portions according to a predetermined grid. For example, a grid of 30 by 40 cells (portions). Alternatively, the portioning may be flexible using a particular algorithm used by both camera 11 and viewing station 12 (and/or imaging server). Such algorithm may be based on a compression and decompression algorithm used to create and to reconstruct the low-resolution images. Such algorithm may, for example, divide the low-resolution image into portions of equal spatial size or equal payload size (e.g., equal number of bytes). Alternatively, portions may be arranged around particular predetermined object types and the type of the objects may be embedded in the portion identifier.

It is appreciated that the any aspect of the portioning may be optional and that part or all of the low-resolution images 53 may be communicated without portioning. In such scenario, for example, portioning may be created by the receiver, such as the remote viewing station or the imaging server.

It is appreciated that steps 50, 52 and 54 may be repeated for any number of cameras, and/or images, and/or image types (such as still pictures, video frames, 3D imaging, thermal imaging, stereoscope images, etc., and combinations thereof), and/or image resolutions to provide, for example, required (increased) resolution, required level of details, required type of details (as in object orientation or image type), etc., and combinations thereof.

Process 47 may then continue with step 56 of procedure 49, where remote viewing station 12, typically operated by a second, or remote, user 15, display low-resolution image 53. Process 47 may then continue with step 57 of procedure 49, where remote viewing station 12 may receive from the second, or remote, user 15, a selection of an image portion associated with a portion identifier 58. Process 47 may then continue with step 59 of procedure 49 sending portion identifier 58 to camera 11. The portion identifier 58 is associated with, and/or defines, a particular portion of low-resolution image 53.

Process 47 may then continue with step 60 of procedure 48, where camera 11 may select or create a higher-resolution image 61. Higher-resolution image 61 is a portion of high-resolution image 51 and/or low-resolution image 53 associated with portion identifier 58, such as image 42 of FIG. 4A.

Portion identifier 58 is typically associated with, and/or defines, or points to, a particular portion of an image, namely an image portion. In this respect a particular portion identifier 58 may be associated with an image portion of high-resolution image 51, and the same or respective image portion of a low-resolution image 53, as well as the same or respective image portion of a higher-resolution image (e.g., an intermediate resolution image). In this respect, portion identifier 58 is typically associated with, and/or defines, or points to, the same image area of the same picture but in different image versions having different resolutions. Portion identifier 58 is therefore associated with a point location within a low-resolution imaging data;

Portion identifier 58 is typically associated with, and/or defines, or points to, a particular image (e.g., imaging data item such as a still picture, a video frame, etc.) and to a particular area (i.e., image portion) within the particular image.

Portion identifier 58 may therefore include, for example, at least one of: image index, frame number, time of acquiring an image, location of acquiring an image, orientation of camera 11 when acquiring an image, etc. Portion identifier 58 may also include, for example, at least one of: a section of the image, an image portion index (numerator), a point within an image, a size of an area of the image associated with the point, etc.

The point within the image may be provided, for example, in terms of X and Y coordinates from a predetermined feature of the image, such as the upper left corner of the image. The point within the image may define a particular point of the image portion, such as the upper left corner of the image portion, the center of the image portion, etc.

The area of the image portion associated with a portion identifier 58 may be predetermined, or selected from a list of predetermined values, or specified particularly as part of the portion identifier 58.

Any of such values may include an absolute value (e.g., date and time), a relative value (e.g., time from the first frame), and/or an index (e.g., a numerator).

It is appreciated that when viewing station 12 sends portion identifier 58 to camera 11, for example, as part of step 59 of procedure 49 of process 47, the portion identifier 58 may include an identification of a particular image and an identification of a particular part, or area, such as an image portion. Typically, initially, the portion identifier 58 is associated with, and/or defines, or points to, a particular portion of low-resolution image 53. However, this portion identifier 58 is associated with, and/or defines, or points to, with the same image portion of the high-resolution image, or higher-resolution image, or intermediate resolution.

Additionally the portion identifier 58 may include information relating to the required size, or area, of the image portion. Additionally the portion identifier 58 may include information relating to the required resolution, or quality, of the requested image portion of the high-resolution image, or higher-resolution image, or intermediate resolution.

As an option, higher-resolution image 61 may be selected by procedure 48 and/or camera 11 as a particular area of high-resolution image 51 associated with portion identifier 58.

Alternatively, higher-resolution image 61 may be created by procedure 48 and/or camera 11 by converting the particular area of high-resolution image 51 associated with portion identifier 58 into an image of any particular resolution. For example, higher-resolution image 61 may have intermediate-resolution, being higher than the resolution of low-resolution image 53 and lower than the resolution of high-resolution image 51.

Process 47 may then continue with step 62 of procedure 48 by sending low-resolution image 53 to a remote viewing station 12.

Process 47 may then continue with step 63 of procedure 49, where remote viewing station 12 may display higher-resolution image 61.

It is appreciated that higher-resolution image 61 may represent a close-up, or a zoom-in view of the low-resolution image 53, for example, concentrating on the area associated with the portion identifier 58. Optionally or additionally, portion identifier 58 may specify a particular time in which the higher-resolution image 61 was captured (e.g., photographed) by camera 11.

It is appreciated that alternatively or additionally, higher-resolution image 61 may represent increased time-resolution. For example, the low resolution image data may have low frame-rate (relatively few frames-per-second) and the request for higher resolution (which may be implemented by portion identifier 58) may include a request for a higher frame-rate.

Alternatively or additionally, the low resolution imaging data may include only some of the images captured by camera 11 and the request for higher resolution (which may be implemented by portion identifier 58) may include a time indication requesting an image created by camera 11 between two low-resolution images′. In this respect, the request for ‘higher resolution image’ (which may be implemented by portion identifier 58) may actually indicate an image created by camera 11 during a time between capture of two images (e.g., ‘forming lower-resolution images’) previously communicated from camera 11 to remote viewing station 12 and/or imaging server 16.

It is appreciated that higher-resolution image 61 may include a different type of images (such as still pictures, video frames, 3D imaging, thermal imaging, stereoscope images, etc.) than the image type of the low-resolution image 53, or a combination of types having the same or higher resolution.

It is appreciated that higher-resolution image 61 may include any combination of a particular area (i.e., spatial zoom-in), a particular time (i.e., temporal zoom-in), and a particular imaging type (i.e., particular imaging technology).

It is appreciated that any one of the particular spatial zoom-in area, the particular temporal zoom-in time, and the particular imaging type provided in portion identifier 58 may be predetermined. For example, to enable the remote user to request a higher-resolution image with for example, a single click (or any other type of user-interface requiring minimal user interaction).

It is appreciated that steps 57, 59, 60, 62 and 63 may be repeated for any number of resolutions, types of images, image portions, parts and/or areas, and combinations thereof. For example, repeating steps 57, 59, 60, 62 and 63 may result in camera 11 sending to a remote viewing station 12 images having gradually increased resolution, or close-up, or zoom-in. For example, repeating steps 57, 59, 60, 62 and 63 may result in camera 11 sending to a remote viewing station 12 a higher-resolution image 61 in the form of the image presented in FIG. 4C. Steps 57, 59, 60, 62 and 63 may be repeated to provide close-up view, zoom-in view, increased resolution; and/or required level of details.

It is appreciated that steps 57 to 63 may be executed and/or repeated in parallel with steps 50 to 56. In other words, procedure 49 and/or viewing station 12 may acquire higher-resolution images 61 while procedure 48 and/or camera 11 further acquire successive high-resolution images 51. Similarly, procedure 49 and/or viewing station 12 may acquire higher-resolution images 61 while procedure 48 and/or camera 11 communicate these further acquired successive images as low-resolution images 53 to viewing station 12.

The system for remotely controlling communicated image resolution 10 may use the bandwidth available from communication network 13 to enable communicating both low-resolution imaging data and high-resolution imaging data, substantially simultaneously.

The term ‘substantially simultaneously’ here means that low-resolution data and high-resolution data share the bandwidth, so that both are transmitted in parallel, though typically a particular high-resolution data is associated with low-resolution (image portion) data transmitted earlier.

In one example, when camera 11 converts high-resolution imaging data 51 into low-resolution imaging data 53 camera 11 considers the bandwidth available from communication network 13 so as to leave some of the bandwidth available for the transmission of the high-resolution imaging data 61 without degrading or delaying the transmission of the low-resolution imaging data 53.

Therefore, process 47 may enable second, remote, user 15 to zoom in, and/or view a close-up portion of the image taken by camera 11, in real-time or near-real-time, or on-line, without having to communicate the entire high-resolution image 51 as taken by camera 11.

It is appreciated that the action of converting to low-resolution (step 52 of FIG. 5) may include any of the resolution types described herein and/or combinations thereof, where the conversion to low-resolution may include decreasing any of spatial resolution, temporal resolution, color resolution and increased compression. In this respect, the portion identifier 58 may include a particular type (aspect) of resolution to be enhanced (such as spatial, temporal and color resolution, depth, bandwidth, compression type, etc.). For example, remote viewing station 12 may enable the second (remote) user 15 to select such resolution type to be enhanced.

It is appreciated that the action of selecting or creating a higher-resolution image (step 60 of FIG. 5) may include selecting the portion (area) of the image associated with the portion identifier selected by the remote user and sending it in a higher-resolution mode. In other words, either in the original high-resolution form, or by converting the original image into a lower-resolution image but higher resolution than the previously sent image.

One possible purpose of system 10 is to maintain a constant bandwidth, or bit rate between camera 11 and viewing station 12, or load, over communication network 13. For example, by adjusting the size of the area of the image portion to the amount of data of the higher resolution image. In this manner, as the resolution increases and the amount of data per area unit increases, the amount of image portion area transmitted may be respectively decreased to maintain substantially constant bit rate, or bandwidth, or load.

Therefore, system 10 may divide the available bandwidth between the stream of low-resolution image and the stream of high-resolution portions. For example, system 10 and/or camera 11 may determine the characteristics of the low-resolution image (e.g., bandwidth, compression type, number of pixels, bits-per-pixel, etc.) according to the available bandwidth, leaving sufficient bandwidth to enable transmitting the high-resolution image portions substantially simultaneously with the low-resolution image. For example, the camera can send low-resolution image data as it is captured, and in parallel send the high-resolution image data requested by the viewing station for a previously transmitted and received low-resolution image data. Consequently, system 10 may enable sending the high-resolution image portions without disrupting the stream of low-resolution image.

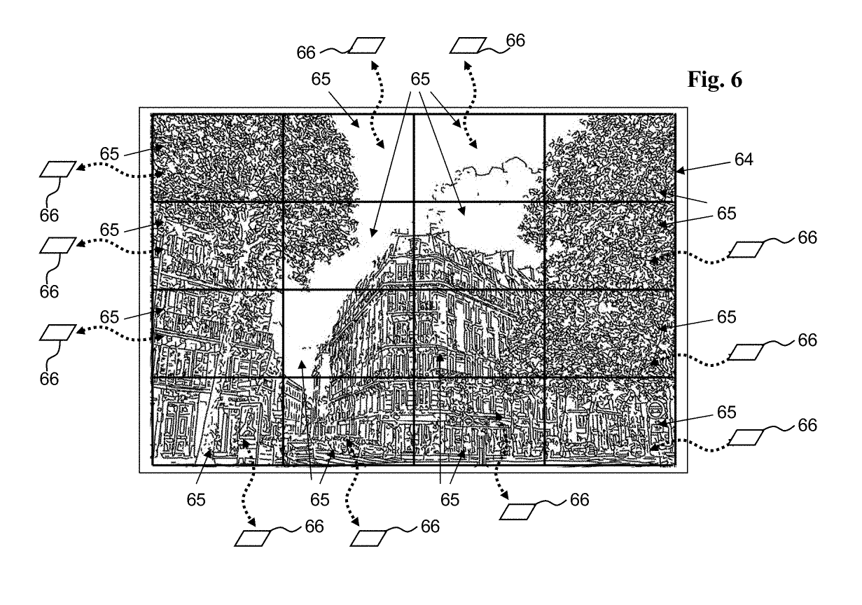

Reference is now made to FIG. 6, which is a simplified illustration of an image 64 divided into image portions 65, and associated with respective portion identifiers 66, according to one exemplary embodiment.

As an option, the illustration of FIG. 6 may be viewed in the context of the details of the previous Figures. Of course, however, the illustration of FIG. 6 may be viewed in the context of any desired environment. Further, the aforementioned definitions may equally apply to the description below.

As shown in FIG. 6, image 64 may include a plurality of image portions 65. Image portions 65 may be adjacent as shown in FIG. 6, or at least partially overlapping. Each image portion 65 is associated with a respective portion identifier 66. Portion identifier 66 may be a data element uniquely identifying the respective image portion 65.

When camera 11 sends an image to viewing station 12 it may also send a list of portion identifiers 66 identifying the image portions 65 making the image, such as image 64. Camera 11 may also send to viewing station 12 division data including a description of the division of image 64 into image portions 65. The division data may define the boundaries of image portions 65, or the center points, shape and size of the respective image portions 65, or any similar and adequate manner of describing the location and boundaries of the image portions 65 making the transmitted image.

It is appreciated that any image sent from camera 11 to viewing station 12 may be divided into image portions, including low-resolution images such as image 53 of FIG. 5, and higher-resolution images such as image 61 of FIG. 5.

The user of viewing station 12 may then select a particular image portion 65 for which a close-up or zoom-in view is required. The respective portion identifier 66 associated with the selected image portion 65 may then be sent by camera 11 to viewing station 12 as in steps 57 and 59 of FIG. 5.

It is therefore appreciated that in one alternative, a remote user 15 may select an image portion by pointing at a particular point in an image. The location values of the selected point is then transmitted by viewing station 12 to camera 11 as a portion identifier. Camera 11 then creates an image portion around the communicated portion identifier.

In a second alternative, a remote user 15 may select an image portion by pointing at a particular point in an image. The image is already divided into image portions and viewing station 12 may then determine the image portion pointed at by remote user 15. Viewing station 12 may then send to camera 11 the portion identifier associated with the selected image portion. Camera 11 then selects the image portion associated with the selected portion identifier.

In a third alternative, camera 11 may pre-divide the high-resolution image into a plurality of portions according to the amount of details in each image portion. Image portions having more details per area unit or time unit being smaller than image portions having less details so that all image portions have about the same number of details or the same rate of loss of data due to compression (higher loss—smaller image portion). The number of details, or detail density, may refer to spatial details, temporal details (associated, for example, with the speed of camera motion, or the speed of the photographed subject, etc.), color depth, etc.

While the first alternative is more flexible, the second alternative enables camera 11 to store the high-resolution images as a plurality of image portions, rather than to create the required image portion from the original image.

Viewing station 12 may enable remote user 15 to select an image portion or a portion identifier by displaying an image (such as image 42 of FIG. 4A, or image 53 of FIG. 5) on a display of viewing station 12, and receiving from remote user 15 a selection of a particular image portion or portion identifier by pointing at a particular part or point of the displayed image. For such pointing, remote user 15 may use a pointing device such as a mouse, a touch sensitive screen, or any other adequate point-and-select technology and/or device.

Viewing station 12 may display within the image, the boundaries of the image portions, particularly for pre-divided image portions, to enable the remote user 15 to select the most appropriate image portion and/or portion identifier.

When selecting an image portion (e.g., requesting a close-up view or zoom-in) the viewing station 12 may enable remote user 15 to select the required resolution type, resolution level and/or increase, a level of or close-up and/or zoom-in view, etc. Resolution type may specify, for example, spatial resolution, temporal resolution, color resolution, level of data loss, etc. resolution level may specify, for example, a level number (index), pixel density (e.g., number of pixels per unit of area), pixel size, number of bits per pixel, number of frames per second, etc. Increase level may be specified, for example, as a level increase value, or as a percentage value.

Viewing stations 12 also enables remote user 15 to select an image portion or a portion identifier of a first image and receive a higher-resolution adjacent image portion. The adjacent image portion is indirectly associated with the selected image portion or portion identifier. Therefore, viewing stations 12 provides remote user 15 with higher-resolution panning. In this respect, system 10 may provide viewing stations 12 with a sequence of associated image such as adjacent images having the same image resolution, or image type, or object, also from a different camera, or combinations thereof.

Viewing stations 12 also enables remote user 15 to select an image portion of the same object taken at a different time. The term ‘same object’ here refers to an image of substantially the same photographed object or objects. The term ‘photographed’ here refers to any imaging technology.

In this respect, a first portion identifier of a first image portion of a first image is indirectly associated with a second portion identifier of a second image portion of a second image of the same object (e.g., object orientation).

In this respect, the first image portion and the second image portion are at least partially overlapping, or at least partially sharing content. The first image portion and the second image portion may be acquired by the same camera at different times, by different cameras, or using different technologies.

The terms ‘indirectly associated’ or ‘indirect association’ refers to the data relation or connection between the first portion identifier and the second portion identifier enabling the connection between the first image portion and the second image portion.

Viewing station 12 may also enable remote user 15 to send to camera 11 a request for a second high-resolution image associated with the (first) image portion currently displayed, where the second high-resolution image is taken in a different time. Camera 11 may then send to viewing stations 12 the second high-resolution image. It is appreciated that first image portion and the second image portion are indirectly associated, for example, via their respective portion identifiers.

As described herein, an image portion is identified by its portion identifier and portion identifiers of the same object (as defined herein) taken at different time, or different cameras, or using different technologies, may be associated (forming indirect association of the image portions).

However, as shown and described above, image portions and their respective portion identifiers may be defined ‘on-the-fly’ rather than being predefined. As shown and described above, a remote user 15 at viewing station 12 may select a particular point of an image displayed by viewing station 12. Viewing station 12 then creates a portion identifier associated with the selected point and send it to camera 11. Thereafter camera 11 defines the image portion around the portion identifier. The term ‘around’ here means that the area of the image portion as defined by camera 11 is associated with the location of the portion identifier.

The portion identifier is therefore associated with the image, or with the photographed object, for example, by way of distance from a particular feature of the image. The distance may be measured from the corner of the image or from the photographed object. The distance may be measured in terms of physical distance (e.g., centimeters) or pixels, or any other measuring technology, whether Cartesian or Polar.

The image portion created by camera 11 around the portion identifier provided by the viewing station 12 may be determined according to various rules such as a predetermined area, a predetermined number of pixels, a predetermined amount of data, etc.

Alternatively, the image portion may be created according to the number of pixels that the viewing station 12 may display. For example, when a mobile device such as a smartphone or a tablet is used as a viewing station 12 it may send with the portion identifier one or more parameters of its display device such as the number of pixels of the display. Camera 11 may then create the required image portion around the portion identifier with respect to the display parameters of the viewing station 12.

Returning to FIG. 1, it is appreciated that two or more local users 14 may be co-located and/or use respective cameras 11 to take images of the same object. These images may be different, for example, being taken from different angles (respective to the photographed subject), camera orientations, time, etc. Alternatively or additionally, the same user may use two or more different cameras such as a still image camera, a video camera, a 3D camera, a thermal camera, etc. It is appreciated that the plurality of cameras may be mounted on the same mobile equipment.

Images of this plurality of cameras may be transmitted to one or more viewing stations 12 and observed by one or more remote users 15. Hence, a remote user 15 may request, for example by pointing at an image displayed on the display screen of viewing station 12, to receive and display a higher-resolution image acquired by a different camera or a different technology and correlated or associated with the selected image portion or portion identifier.

It is appreciated that images from different cameras may be correlated and not necessarily associated with the same photographed object. For example, a mobile device such as a smartphone may have two cameras, a first, forward looking, camera, pointed away from the user, and a second, backward looking camera, pointed at the user. Similarly, a car camera device may have a forward-looking and backward-looking cameras, or sideways looking cameras, or a panorama view cameras, etc.

For example, remote user 15 at viewing stations 12 may select a camera, such as a forward-looking, or a backward-looking camera. Remote user 15 at viewing stations 12 may, for example, request an image taken by the backward looking camera associated with an image taken by the forward looking camera, or vice versa. Remote user 15 at viewing stations 12 may, for example, request an image portion taken by the backward looking camera associated with an image portion taken by the forward looking camera, or vice versa.

It is therefore appreciated that a portion identifier of an image taken by a first camera may be associated or correlated with an image portion of another image taken by another camera, whether at the same time, the same angle or orientation (or reverse angle or orientation, etc.), or the same photographed object.

The images and/or image portions taken by different cameras may by partially overlapping. Therefore, when remote user 15 at viewing stations 12 views a first image taken by a first camera and requests an image portion taken by another, second, camera the second image portion (from the second camera) may have details outside the boundary of the first image portion (from the first camera). This process may also be implemented with different images taken substantially successively or at different times by the same camera.

Remote user 15 at viewing stations 12 may select an image portion or a portion identifier of a first image and receive a higher-resolution image portion taken by a different camera or a different imaging technology indirectly associated with the selected image portion or portion identifier. Therefore, viewing stations 12 provides remote user 15 with higher-resolution panning between cameras, or between imaging technologies.

As described herein, remote user 15 at viewing stations 12 may select the resolution, and/or imaging technology and/or camera 11 from which the required image is sourced. Therefore, when switching between cameras 11 or between imaging technologies (or both) remote user 15 may retain the resolution, or the close-up parameters, or zoom-in parameters (such as distance from the photographed object) or the requested image portion.

It is appreciated that system 10 enables its users to select an image portion where the selected image portion is any of:
adjacent to another (previous, first) image portion;
at least partially overlapping another (previous, first) image portion;
including same resolution as another (previous, first) image portion;
including same area size as another (previous, first) image portion; and
including same number of pixels as another (previous, first) image portion.

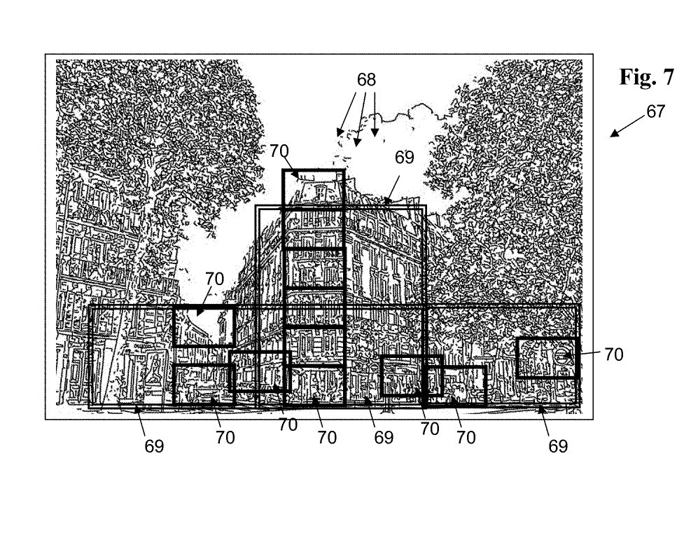

Reference is now made to FIG. 7, which is a simplified illustration of an image 67 having preselected image portions 68, according to one exemplary embodiment.

As an option, FIG. 7 may be viewed in the context of the details of the previous Figures. Of course, however, the illustration of FIG. 7 may be viewed in the context of any desired environment. Further, the aforementioned definitions may equally apply to the description below.

In the scenario associated with FIG. 7, camera 11 limited the image portions 68 that the viewing stations 12 may retrieve to specified selected areas of image 67. Thus, for example, camera 11 may store high-resolution (or higher-resolution, or intermediate-resolution) imaging data only for particular parts of image 67, thus for example, saving storage space.

As shown in FIG. 7, camera 11 may provide for image 67 a low-resolution imaging data for the entire image 67, intermediate-resolution imaging data for image portions 69, and high-resolution imaging data for image portions 70.

As shown in FIG. 7, image portions 69 and/or 70 may be positioned as adjacent continuously or sharing borders. Alternatively, or additionally, image portions 69 and/or 70 may be scattered such as without sharing borders. Alternatively, or additionally, image portions 69 and/or 70 may be at least partially overlapping.

Camera 11 may select the parts or portions of an image that should be saved in any type of resolution based on the amount and/or type of information lost in the conversion to low-resolution version of the image. For example, camera 11 may select to save in high or higher resolution parts or portions of an image containing text.

As disclosed above, camera 11 may use various algorithms to determine which parts of the image to save in high-resolution. For example, the algorithm may select as saved portions parts of the image that are more ‘lossy’ when compressed. That is to say that loss details when compressed into low-resolution are saved in high-resolution.

Alternatively, camera 11 may select to save in high-resolution parts of the image that are particularly different from previous images of the same place (according to the measured orientation of the camera 11). For example, camera 11 may locate and save in high-resolution portions around particular objects that may be moving within the video stream, whether because the camera is moving or because the object is moving such as a person walking.

As disclosed above, the viewing station may change the method or algorithm used by the camera to decide which portions to store in high-resolution portions by communicating to camera 11 a request to change the current algorithm with a preferred algorithm.

The viewing station may determine the method or algorithm used by the camera to decide which portions to store in high-resolution portions and communicating to camera 11 a request to change the current algorithm with a preferred algorithm.

In this scenario, camera 11 may send to viewing stations 12 the portion identifiers for the image portion for which high-resolution image data is available, for example, as described above with reference to element 55 of FIG. 5. The portion identifiers also include, or are accompanied with, image portion data describing the parameters of the respective image portions, such as location, shape, area, resolution, etc.

The viewing stations 12 may then display to the user the location of the available high-resolution image portions, for example, by displaying the respective portion boundary for each image portion available.

In this scenario, as well as in other scenarios, camera 11 may determine to store high-resolution images including a predetermined area of said low-resolution image, or a predetermined number of pixels from the high-resolution image.

As described herein, it is appreciated that process 47, and particularly, for example, camera 11, and/or procedure 48, may acquire one or more images by a processing device, such as a mobile communication device, comprising an image acquiring device (e.g., camera 11), the image being acquired at high-resolution.

Process 47, and particularly, mobile communication device, optionally including camera 11, and/or procedure 48 may then convert the high-resolution image to a low-resolution thus forming a low-resolution image.

Process 47, and particularly, mobile communication device, optionally including camera 11, and/or procedure 48 may then, optionally, define at least one part of the (high-resolution and/or low-resolution) image as an image portion and associate at least one image portion with a portion identifier.

Process 47, and particularly, mobile communication device, optionally including camera 11, and/or procedure 48 may then communicate the low-resolution image to a remote display device such as remote viewing station 12.

If mobile communication device, and/or procedure 48 have defined the one or more image portions and/or their respective portion identifiers then the definition data of the image portion and/or their respective portion identifiers are also communicated from mobile communication device (e.g., camera 11), and/or procedure 48 to the remote display device (e.g., remote viewing station 12).

The definition data of the image portion may include various parameters such as image index, frame number, date and time of acquiring the image, location of acquiring an image, orientation of camera 11 when acquiring an image, etc., a definition of a section of the image, an image portion index (numerator), a point within an image, the shape of the image portion, a size of an area of the image portion, etc. The image portion location may be provided, for example, in terms of X, and Y coordinates from a predetermined feature of the image, such as the upper left corner of the image. The point within the image may define a particular point of the image portion, such as the upper left corner of the image portion, the center of the image portion, etc.

Process 47, and particularly remote viewing station 12, and/or procedure 49 may then display the low-resolution image on a display of said remote display device in real-time or near-real-time.

Process 47, and particularly remote display device, such as remote viewing station 12, and/or procedure 49 may then receive a user selection of a particular portion of the low-resolution image, thus forming a selected image portion associated with a corresponding portion identifier.

The selected image portion may be selected from image portions and/or portion identifiers received from the mobile device (e.g., camera 11), or determined and created by remote viewing station 12.

Process 47, and particularly remote display device, such as remote viewing station 12, and/or procedure 49 may then communicate the portion identifier to the mobile communication device (e.g., camera 11).

If the required image portion and/or portion identifier has been determined and created by the remote display device (e.g., remote viewing station 12) the remote display device may also communicate to the mobile communication device (e.g., camera 11) the definition data of the image portion, as described above.

The remote display device (e.g., remote viewing station 12) may enable the user to determine or to select such definition data of the image portion, or use a one or more default values, such as a predetermined area of the low-resolution image, or a predetermined number of pixels of the high-resolution image, etc.

Process 47, and particularly mobile communication device (e.g., camera 11) and/or procedure 48 may then communicate a high-resolution image associated with said selected image portion, or portion identifier to the remote display device, providing a close-up (zoom-in) view of the low-resolution image including the selected image portion.

It is appreciated that system 10 for remotely controlling communicated image resolution may include a plurality of image acquiring devices (e.g., a plurality of cameras 11) and/or a plurality of remote display devices (e.g., a plurality of remote viewing stations 12). Therefore, process 47 may include a plurality of procedures 48 and/or a plurality of procedures 49.

It is appreciated that system 10 enables a particular image acquiring device (e.g., camera 11) to communicate with a particular remote display devices (e.g., remote viewing station 12). System 10 also enables a particular plurality of image acquiring devices (e.g., cameras 11) to communicate with a particular remote display devices (e.g., remote viewing station 12). System 10 also enables a particular image acquiring device (e.g., camera 11) to communicate with a particular plurality of remote display devices (e.g., remote viewing stations 12). System 10 also enables a particular plurality of image acquiring devices (e.g., cameras 11) to communicate with a particular plurality of remote display devices (e.g., remote viewing stations 12).

For example, in a situation where a plurality of cameras 11 acquire a respective plurality of images of the same object the image data sent by a camera 11 to the remote viewing station 12 may include identification of the camera 11. Therefore, the image-portion selection in the remote viewing station 12 may also include selecting the image acquiring device (e.g., a particular camera 11).

When a user of a remote viewing station 12 selects an image portion the user may select to receive a particular image type (or image technology). Such selection may include, for example, a 3D image (or an image including 3D data), a higher-resolution 3D image; and adding the 3D image, or data, to the image portion as viewed. It is appreciated that any such combination of technologies is contemplated and made available. For example, adding thermal image, or data. Adding 3D image or data over a thermal image or data, etc.

A user of remote viewing station 12 may have several options to determine an image portion:

The user may select a predetermined image portion. The portioning, and/or the available image portions, are typically determined by the camera 11, however, alternatively, the portioning, and/or the available image portions the viewing station 12.

The user may select an arbitrary image portion, either by indicating the area of the image portion, or by indicating a point about which the area of the image portion is determined automatically. Typically, the area is automatically determined by the viewing station 12, however, alternatively, the area can be determined by the camera 11.

The user may select a visual object. The user may select a predetermined object. Such object may be automatically determined by the viewing station 12, or by the camera 11. The user may also select an arbitrary object.

Typically, when a user of remote viewing station 12 selects an image portion or an object in a particular image, using any of the methods described, the remote viewing station 12 requests from camera 11 a higher-quality (higher-resolution) image of the selected image portion or object in the same particular image.

Alternatively or additionally, the remote viewing station 12 may request from camera 11 higher-quality (higher-resolution) image of the selected image portion or object from any number of images including the selected image portion or object.

Alternatively or additionally, the remote viewing station 12 may request from camera 11 the best higher-quality (higher-resolution) image of the selected image portion or object from any number of images including the selected image portion or object. Therefore camera 11 executes an algorithm analyzing and/or comparing the quality of the requested image portions or objects to determine the best image portion or object and communicate it to the remote viewing station 12.

Alternatively or additionally, if the remote viewing station 12 has acquired a best higher-quality (higher-resolution) image of the selected image portion or object the remote viewing station 12 may apply this best higher-quality image to all images including the selected image portion or object.

Alternatively or additionally, if the remote viewing station 12 acquired a plurality of image portions or object images of the same spot or object, the remote viewing station 12 may execute such algorithm for analyzing and/or comparing the quality of the requested image portions and thereafter apply the best higher-quality image to all images including the selected image portion or object.

To identify a best portion or best image the camera or the viewing station may analyze a plurality of images containing the requested image portion or object, for example, according to a criterion including a parameter, or a group of parameters, or a particular weighting of such group of parameters, or an algorithm calculating a value representing, for example, such weighted group of parameters. The criterion may be selected by the camera or by the remote viewing station, or by the user of the remote viewing station. For example, such selection may indicate image selection according to brightness, contrast, color depth, etc.

Therefore, any particular image (e.g., a video frame or a still picture) may be enhanced by importing any number of high-quality image portions or object images from any number of other images, taken earlier, later, and/or by any other camera.

It is appreciated that a video stream may be similarly enhanced by using a ‘best portion’ of any particular still (non-moving) object. When a user captures a video stream of a still object, such as scanning over a landscape, an urban environment, a hall, etc., the video stream captures the same still objects repeatedly in successive frames. However, for various reasons such as change of lighting, camera motion, an object moving between the camera and the still object, etc., the quality of capturing any particular object may change between frames. The camera and/or the viewing station may determine a ‘best portion’ or ‘best image’ for each of a selection of image portions and/or objects, and hereafter implant the best portion or best image in all other frames where applicable.

A best portion or best image may be determined, indicated, and/or acquired from the camera by indicating the location of the portion within the image, and/or by identifying a particular visual object within the portion.

The viewing station may send an identification of a particular object, or a feature of a particular object, within a particular portion of a particular frame, and request the camera (or the hosting computing device) to provide the exact location of the object, or object feature, within the image. Such location may be provided for example, as the distance from a corner of the frame, in terms of millimeters, pixels, etc.

The viewing station may request, and the camera (or the hosting computing device) may provide, the exact location of an object, for any number of frames. For example, the viewing station may indicate the object in a particular frame the exact location may be provided and obtained for the other frames. In this scenario the camera (or the hosting computing device) may determine the exact location of the object based on high-quality images that were not communicated to the viewing station. Therefore, the viewing station may accurately position a high-quality image of the object in a low-quality frame.

Localizing an object within a frame may be based on the distance of the object within an image portion including an image of the object, and localizing the image portion within the frame. Localizing the object image in the image portion, and localizing the image portion within the frame, may be provided by measuring distance, or coordinates, for example in millimeters or number of pixels, from a known feature of the respective image portion or frame, such as the upper left corner. For example, the distance of the upper left corner of the image portion from the upper left corner of the frame. For example, the distance of a particular feature of the object image from the upper left corner of the image portion. Therefore, the viewing station may communicate to the camera, and/or the camera may communicate to the viewing station, an identification of the particular feature of the object designating the distance, for example, from the upper left corner of the image portion.

Alternatively, an object image can be localized in a frame by providing a measure, such as distance, for example by means of coordinates, from one or more other objects, or a respective designated feature of such object or objects. Such objects may reside in the same image portion, or in different image portions, therefore creating a spatial object network. It is appreciated that the accuracy of the object localization within the spatial object network may be higher than viewed in the low-resolution imaging communicated from the camera to the viewing station.

Alternatively, or in addition to the localization methods described above, the camera (or the hosting computing device) may provide the remote viewing station localization and/or orientation data (for any of frame, image portion, object, etc.) in polar coordinates, and or with respect to the geographic and/or magnetic pole.

Additionally and optionally, the remote viewing station 12 may automatically analyze the preferences of the user operating remote viewing station 12 (remote user 15). For example, the remote viewing station 12 may automatically analyze and characterize the image parts and/or objects for which remote users creates a portion identifier or otherwise requests a higher quality image portion (or object image). The remote viewing station 12 may identify such typical image parts and/or objects and further characterize them according to a particular remote user 15, according to a particular local, user 14, according to a particular location, according to a particular type of location, etc.

Based on the above analysis of preferred image parts and/or objects the remote viewing station 12 may automatically recognize such preferred image parts and/or objects in the image displayed by the remote viewing station 12 and mark these image parts and/or objects.

The remote viewing station 12 may further automatically request camera 11 to store high-quality data for such preferred image parts and/or objects, and/or to automatically transmit high-quality data for such preferred image parts and/or objects with their respective low-resolution images.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A method for communicating image, the method comprising:
acquiring said image by a mobile communication device comprising an image acquiring device, said image being acquired at high-resolution;
converting said image to low-resolution by said mobile communication device to form a low-resolution image;
associating at least one portion of said low-resolution image with a portion identifier;
communicating said low-resolution image and said at least one portion identifier from said mobile communication device to a remote display device;
displaying said low-resolution image on a display of said remote display device in real-time;
receiving a user selection, at said remote display device, of a portion of said low-resolution image to form a selected image portion to form an image-portion selection, wherein said selected image portion is associated with a portion identifier;
communicating said portion identifier to said mobile communication device; and
communicating a high-resolution image associated with said selected image portion from said mobile communication device to said remote display device;
wherein said high-resolution image is a close-up (zoom-in) view of said low-resolution image including said selected image portion.

2. The method of claim 1 wherein said image is at least one of a still picture and a video stream.

3. The method of claim 1 wherein said remote display device is a mobile communication device.

4. The method of claim 1 wherein said at least one portion of said portion identifier is associated with at least one of: portion index, frame number, time of acquiring said image, location of acquiring said image, orientation of said camera when acquiring said image, and section of said image.

5. The method of claim 4 wherein at least one of said portion identifier comprises at least one of an absolute value, a relative value, and an index.

6. The method of claim 1 wherein said step of determining said portion comprises pointing at said portion on said display.

7. The method of claim 7 wherein said output device of said remote display device comprises a touch-screen display.

8. The method of claim 1 wherein said resolution comprises at least one of spatial resolution (pixel density), temporal resolution, (frame-rate), color resolution (bits per pixel), and loss of data due to compression.

9. The method of claim 8 wherein said step of determining said portion comprises selecting high-resolution of at least one of said spatial resolution, temporal resolution, color resolution, and loss of data.

10. The method of claim 1 additionally comprising:
dividing said image at said mobile device into a plurality of portions according to loss of data due to compression (higher loss—smaller portion).

11. The method of claim 1 additionally comprising
displaying portion boundary on said display.

12. The method of claim 1 wherein said mobile communication device comprises a plurality of image acquiring devices and wherein said step of receiving said image-portion selection comprises selecting an image acquiring device of said plurality of image acquiring devices.

13. The method of claim 12 wherein at least one of said plurality of image acquiring devices is a three-dimensional (3D) scanner, and wherein at least one of:
said image comprises 3D data,
said high-resolution comprises 3D data; and
said step of determining a portion of said image comprises adding said 3D data to said portion.

14. The method of claim 12 wherein said step of selecting an image acquiring device comprises selecting at least one of a forward-looking camera and a backward-looking camera.

15. The method of claim 14 wherein said step of receiving said image-portion selection comprises selecting at least one of:
an image portion taken by said forward-looking camera and associated with an image portion taken by said backward-looking camera; and
an image portion taken by said backward-looking camera and associated with an image portion taken by said forward-looking camera.

16. The method of claim 1 wherein said steps of receiving a user selection at said remote display device of a portion of said low-resolution image, communicating said portion identifier to said mobile communication device, and communicating a high-resolution image associated with said selected image portion from said mobile communication device to said remote display device, are executed repeatedly to provide at least one of:
increased resolution; and
required level of details.

17. The method of claim 1 wherein said steps of communicating said portion identifier to said mobile communication device, and communicating a high-resolution image associated with said selected image portion from said mobile communication device to said remote display device, are executed repeatedly to provide an adjacent image portion.

18. The method of claim 17 wherein said adjacent image portion comprises resolution of previous image portion.

19. The method of claim 1 additionally comprising at least one of:
sending, from said remote device to said mobile communication device, a request for a second high-resolution image associated with said same image portion and taken in a different time; and
sending, from said mobile communication device to said remote device, a second high-resolution image associated with said same image portion and taken in a different time.

20. A method for communicating image, the method comprising:
acquiring said image by a mobile communication device comprising an image acquiring device, said image being acquire at high-resolution;
converting said image to low-resolution by said mobile communication device to form a low-resolution image in real-time;
communicating said low-resolution image from said mobile communication device to a remote display device in real-time;
displaying said low-resolution image on a display of said remote display device in real-time;
receiving a user selection, at said remote display device, of a point location within said low-resolution image;
communicating said point location to said mobile communication device; and
communicating a high-resolution image associated with said selected image portion from said mobile communication device to said remote display device;
wherein said high-resolution image covers a part of said low-resolution image including said point location.

21. The method of claim 20 wherein said high-resolution image includes at least one of:
a selected area of said low-resolution image;
a selected number of pixels of said high-resolution image;
a selected time between two of said low-resolution image; and
a selected frame-rate.

22. The method of claim 20 wherein said high-resolution image includes at least one of:
a predetermined area of said low-resolution image;
a predetermined number of pixels of said high-resolution image;
a predetermined time between two of said low-resolution image; and
a predetermined frame-rate.

23. The method of claim 20 wherein said remote display device is a mobile communication device and wherein said predetermined number of pixels is adapted to a display of said remote display device.

24. The method of claim 20 additionally comprising:
receiving a user selection, at said remote display device, of a second point location, said second point location selected within said high-resolution image;
communicating a second point location to said mobile communication device; and
communicating a second high-resolution image associated with said second point location from said mobile communication device to said remote display device;
wherein said second high-resolution image covers a second part of said low-resolution image including said second point location.

25. The method of claim 24 wherein said second high-resolution image is at least one of:
adjacent to said first high-resolution image;
partially overlapping said first high-resolution image;
including same resolution as said first high-resolution image;
including same area size as said first high-resolution image; and
including same number of pixels as said first high-resolution image.

26. A processing device comprising:
an image acquiring module configured to acquire high-resolution imaging data;
a resolution conversion module configured to convert said high-resolution imaging data into low-resolution imaging data; and
a communication module configured to:
communicate said low-resolution imaging data to a remote display device;
receive from said a remote display device a portion identifier associated with a user selection at said remote display device of a portion of said low-resolution imaging data; and
communicate a high-resolution imaging data associated with said selected image portion to said remote display device;
wherein said high-resolution imaging data is a close-up (zoom-in) view of said low-resolution imaging data including said selected image portion.

27. The processing device according to claim 26 wherein said portion identifier is at least one of:
a point location within said low-resolution imaging data;
associated by said mobile processing device with at least one portion of said low-resolution imaging data, and communicated by said mobile processing device to said remote display device; and
associated by said remote display device with at least one portion of said low-resolution imaging data, and communicated by receive by said mobile processing device from said remote display device.

28. A processing device comprising:
a communication module configured to:
receive a low-resolution imaging data from another processing device; and
transmit to said another processing device a portion identifier associated with a portion of said low-resolution imaging data;
receive from said another processing device a high-resolution imaging data associated with said portion identifier;
wherein said high-resolution imaging data is a close-up (zoom-in) view of said low-resolution imaging data including said selected image portion.

29. The processing device according to claim 28 additionally comprising:
a display module configured to display to a user at least one of said low-resolution imaging data and said high-resolution imaging data;
a user-interface module configured to receive from said user a selection of at least one of: a point location and an area portion, within said low-resolution image; and
a portion-identifier processing module configured to convert said at least one of a point location and an area portion into said portion identifier.
